(19) United States
(12) Patent Application Publication
(10) Pub. No.: US 2004/0029081 A1
(43) Pub. Date: Feb. 12, 2004

(54) Airbone simulator

(76) Inventors: Vladimir Jaros, (US); Ladislav Kubalek, Praha (CZ)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/297,580

(22) PCT Filed: May 25, 2001
(86) PCT No.: PCT/CZ01/00033

(30) Foreign Application Priority Data
Jun. 13, 2000 (CZ) PUV 2000-10877

(51) Int. Cl. G09B 9/08

(52) U.S. Cl. 434/30

(57) ABSTRACT

Airborne simulator for methodological rehearsing and training of the partial elements and combined activities in various versions of airborne landing. The airborne simulator comprises a basic structure (1) formed by a crane (4) with travel. Suspension modules (2) are attached to the carrying rope (5) of the crane (4). The basic structure (1) is located in the area containing terrain elements (3). The arm of the crane (4) is rotatable within 360° circle and thus allowing both the horizontal movement of the anchoring point of the carrying rope (5) along the arm and the vertical movement of the carrying rope (5) by means of a winch with an electric and manual control.

### TECHNICAL FIELD

The invention relates to an airborne simulator for methodological rehearsal and training of partial elements and combined activities in various versions of airborne landing.

### BACKGROUND ART

Simulation tools used so far in the current training practice enable to rehearse just the partial elements of the airborne landing. There are just limited numbers of those tools and they are mostly the obsolete devices from the material and functionality point of view and they are quite often built in a stationary manner at the places where they lost their functionality due to reorganisations.

### DISCLOSURE OF INVENTION

The above mentioned deficiencies are eliminated by the original airborne simulator according to the invention that comprises a basic structure created by a crane with travel. Suspension modules are fixed to the carrying rope of the crane. The basic structure is located in the area containing terrain elements. Crane arm is rotating in the 360° circle and allows both a horizontal movement of the anchoring point of the carrying rope along the arm and a vertical movement of the carrying rope by means of winch with an electric and manual operation. Carrying capacity of the crane is up to 1200 kg. The crane is provided with means for travelling along rails or with a caterpillar chassis or wheel undercarriage. Suspension modules fixed to the carrying crane rope consists of a helicopter or aircraft cabin and/or a parachute. Cabin contains equipment identical to real cabin equipment such as benches, doors, securing elements and abseil arms. Parachute is provided with accessories identical to real parachute accessories for binding and for simulating parachute control. Terrain elements are formed by ground surfaces such as the concrete, barn floor, mud, sand, water and rock surfaces and/or artificial and country objects, such as buildings, streets, yards, water reservoirs, rock structures and forest stands.

Advantages of the airborne landing simulator as of this invention consists in improvement; higher efficiency and intensity of training of the airborne landing in the simultaneously unobjectionable environment conditions and relatively negligible demands on operation. In addition to the formation and development of the individual airborne landing capacities and skills, it contributes to strengthening of psychical resistance, formation of the positive performance motivation and, on the other hand, to the removal of negative emotions from heights (fear, uncertainty, confusing or rigid behaviour and experiencing, etc.) Modelling of the real terms also allows training and rehearsing the methods for management, communication and organisation of the airborne landing before its start-up, during its course and after its termination on the ground.

Airborne landing simulator surpasses the existing training facilities by its relatively high height of the rehearsed activities and allows to apply a gradual, easier and quicker transfer to the final stage of the airborne training with the flying devices.

Airborne landing simulator enables the simulated training of the airborne landing from a helicopter (aircraft) on parachutes (activity before the parachute jump, leap, control of fall, landing manoeuvre, releasing the parachute above the water surface, etc.), landing by abseiling on the thin mountaineering rope or fast rope, airborne landing from a ground flight up to 30 km/h from the height of 2 m or airborne landing with landing of the helicopter (aircraft). Simulator also allows to rehearse the alighting from the transport and fighting vehicles during their drive.

Simulator further provides the set of the other activities performed in considerable heights such as rope traverses, ropeways on inclined rope, saving of an injured person on the rope, transport of an injured person by the helicopter in suspension on the rope, specific climbing techniques (jümaring, prusiking) etc. The used method of a comprehensive modelling of the situation conditions allows all performances with fall on various surfaces (grass, concrete, sand etc.) and on various structures (buildings, water reservoirs, hilly terrain, etc.).

Proposed invention stresses mobility of the simulator in addition to the methodological, environmental and economic side of its rehearsing intention. Thanks to this property, the simulator can be adjusted to the transportation position in a very short time and moved into a new destination.

### BRIEF DESCRIPTION OF DRAWINGS

Invention will be explained by means of drawings in more details.

FIG. 1 shows axonometric view of the airborne simulator design,

FIG. 2 gives the view of the airborne simulator located in the area with various terrain elements.

FIG. 3, shows a horizontal projection of the airborne simulator and various terrain elements from the top.

### MODES FOR CARRYING OUT THE INVENTION

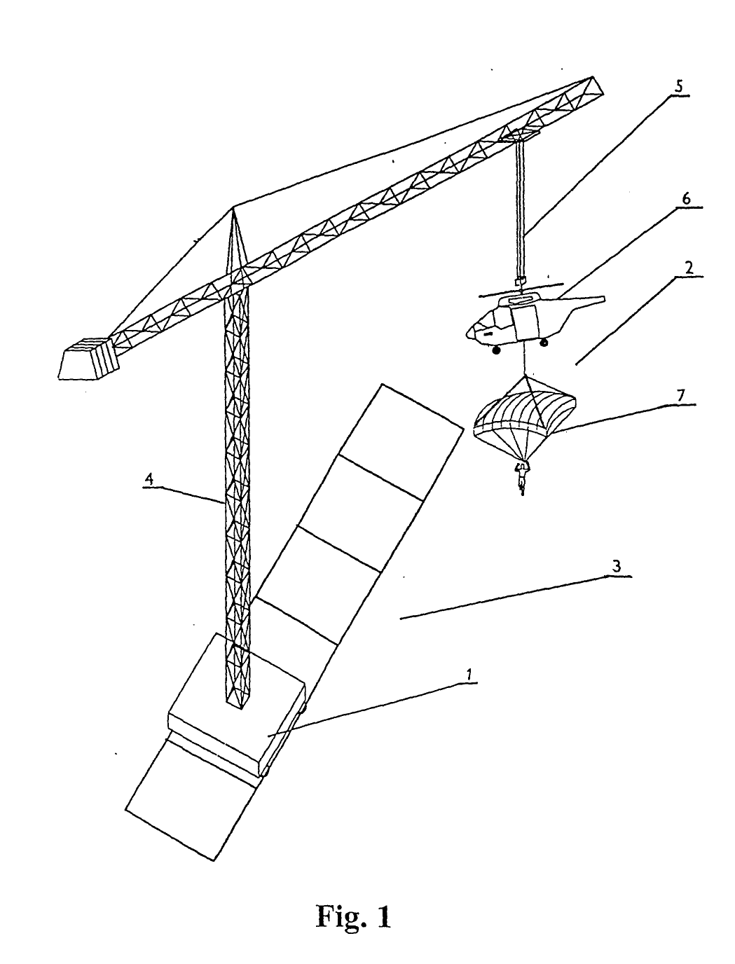

The airborne simulator as of FIG. 1 comprises of the basic structure 1 made by the crane 4 with travel and located at the training area. The crane 4 is provided with the carrying rope 5 to which the suspension module 2, which is the helicopter cabin 6 in the depicted case, is attached. The parachute 7 with a trainee is on the dropping rope 5 attached to the helicopter.

In compliance with the standard, the suspension modules 2 are fixed to the carrying rope 5 and they can move horizontally and vertically. Winch brake of the carrying rope 5 of the crane 4 prevents the modules 2 from falling on the platform and it is possible to control the reeling-up and unwinding speed of the carrying rope 5 by such brake and to select the height for stopping of modules 2 above the ground.

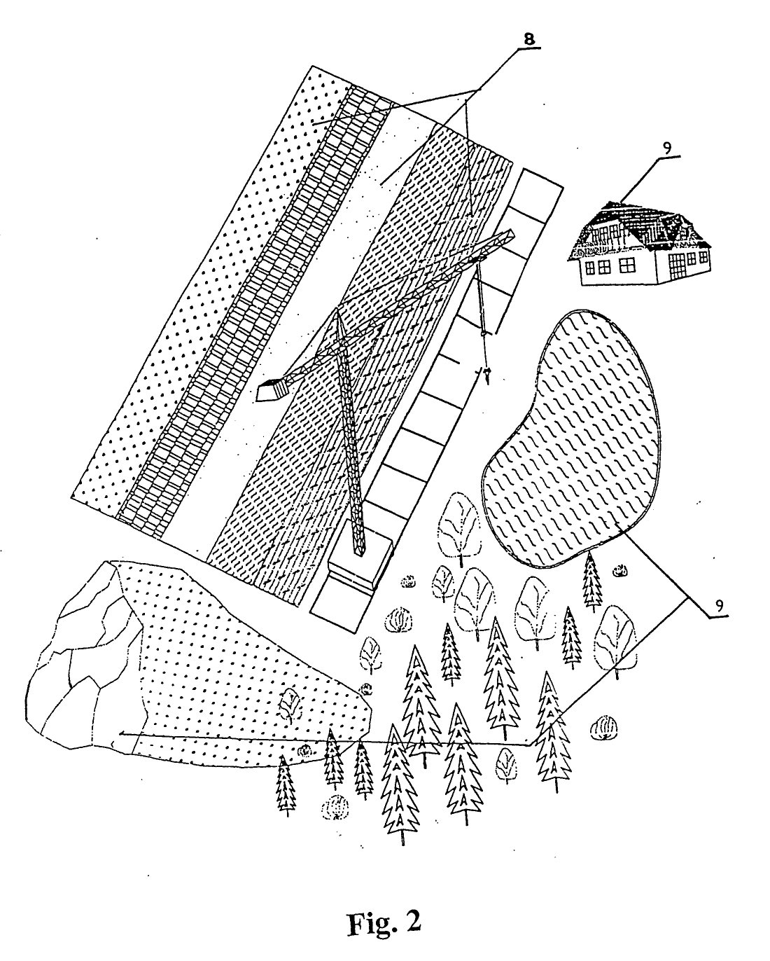

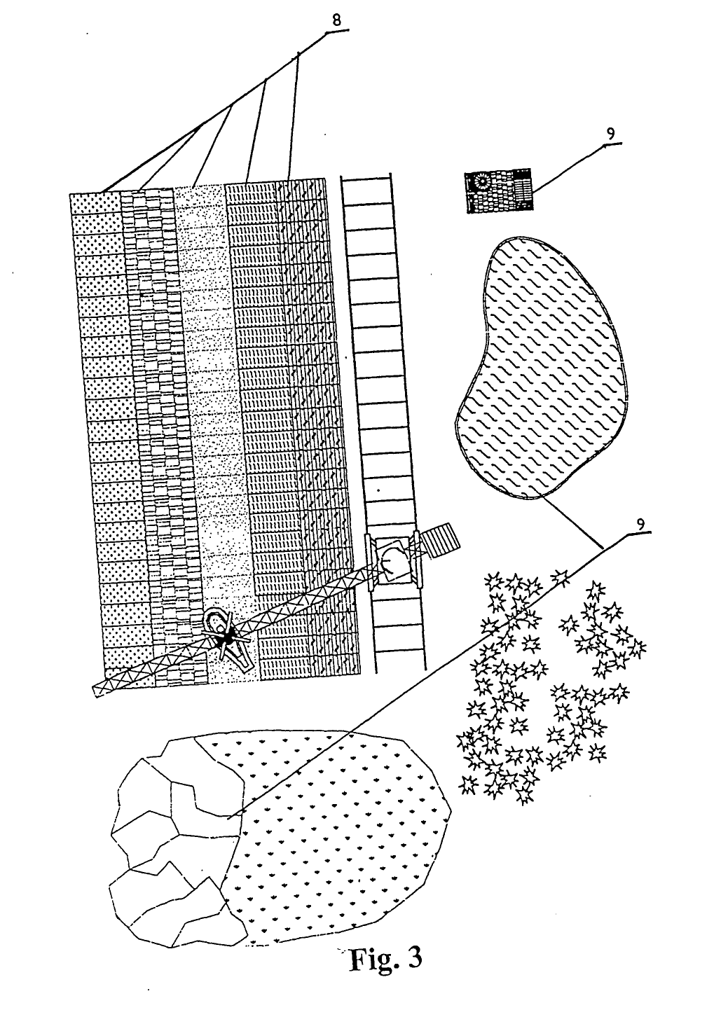

Basic structure 1 as of FIG. 2 and FIG. 3 is located in the area containing the terrain elements 3 that consist of the land surfaces 8 and artificial and country structures 9.

### INDUSTRIAL APPLICABILITY

Invention may be used for preparation of military specialists (paratroopers, feelers, chemical, signalling and engineering specialists, peace-keeping forces, military rescue workers, etc.), police (intervention units, special troops, specialist for transport police, etc.), fire rescue specialists and other rescue units (mountain services, health, water, gas, crude oil and mine rescue services, etc.).

Simulator allows bridging the current sensible outages in the airborne training of all those professions that reflects the decreased subsidies in the growing economic requirements for the flight traffic.

1. Airborne simulator for methodological rehearsing and training of the partial elements and combined activities in various versions of airborne landing characterized by the fact that it comprises a basic structure (1) formed by a crane (4) with travel to the carrying rope (5) of which suspension modules (2) are attached and the basic structure (1) is located in the area containing terrain elements (3), while the arm of the crane (4) is rotatable within 360° circle and thus allowing both the horizontal movement of the anchoring point of the carrying rope (5) along the arm and the vertical movement of the carrying rope (5) by means of a winch with an electric and manual control.

2. Airborne simulator as in claim 1, wherein the crane (4) is provided with means for travelling over rails or is equipped with a caterpillar chassis or wheel undercarriage.

3. Airborne simulator as in claim 1 or 2, wherein the suspension modules (2) are formed by a helicopter or aircraft cabin (6) provided with elements identical to the real cabin equipment, such as benches, doors, securing elements and abseil arms and/or by a parachute (7) provided with accessories identical to the real parachute accessories for binding and for simulated parachute (7) control.

4. Airborne simulator as in claims 1, 2, 3, wherein the terrain elements (3) are formed by ground surfaces (8), such as concrete, barn-floor, grass, mud, sand, water and rock surfaces and/or artificial and country structures (9) such as buildings, streets, yards, water reservoirs, rock structures, forest stand.
